(19) United States
(12) Patent Application Publication
(10) Pub. No.: US 2025/0292178 A1
(43) Pub. Date: Sep. 18, 2025

(54) GLOBAL PREDICTIVE MODELING VIA CUSTOM MACHINE LEARNING MODELS

(71) Applicant: ADP, Inc., Roseland, NJ (US)

(72) Inventors: Kelly Marie Mortimer, Greenlawn, NY (US); Abed K. Shelbayeh, Atlanta, GA (US)

(73) Assignee: ADP, Inc., Roseland, NJ (US)

(21) Appl. No.: 18/605,533

(22) Filed: Mar. 14, 2024

(51) Int. Cl. G06Q 10/0637

(52) U.S. Cl. CPC G06Q 10/06375

(57) ABSTRACT

Predicting impact scenarios is provided. For example, a system integrates one or more processors with a data repository. The system receives a data set including resource utilization of a structure of entities including nodes. The nodes define related entities of the structure of entities using one or more parameters correlated to the data set. The system receives a criteria defining a change in the data set. The system generates a scenario including impacts to a performance of the structure of entities. The system determines that one or more impacts are above a threshold for a first node of the nodes. The system presents the scenario including the one or more impacts to the first node. The system executes an action associated with the scenario for the structure of entities.

### TECHNICAL FIELD

This application is generally related to computing technology, and particularly to prediction of impacts to a structure of entities responsive to a criteria received from a client device.

### BACKGROUND

Heterogeneous computing systems can store, retrieve, and process different types of data across different systems. Structures of entities can make decisions about changes in resource utilization that adversely impact a performance of the structure of entities. The relationships between various entities within the structure can be poorly defined or understood. Due to the complexity of these relationships, entities within a structure of entities frequently implement changes in resource utilization without an understanding of what entities within the structure of entities are affected by the changes in such resource utilization, or without any collaboration from other entities within the structure of entities. Attempts to identify, quantify or otherwise understand relationships between entities within the structure of entities can cause systematic problems including latency, traffic congestion, or delay. Additionally, uninformed actions performed regarding changes in resource utilization can be a source of operational error, resulting in technical challenges.

### SUMMARY

Aspects of the technical solutions described herein facilitate predicting one or more scenarios for a structure of entities using a collaborative process among client devices associated with the structure of entities. The predicted scenarios identify one or more nodes within a structure of entities that are impacted by a change in resource utilization. For example, aspects of the technical solutions described herein facilitate determining one or more scenarios that indicate the amount of impact a change in resource utilization can have on a structure of entities or nodes therein. Some aspects of the technical solutions facilitate determining the impact scenarios using a data set and a criteria received from a client device, and analyzing the impact scenarios to determine what aspects of the structure of entities might be affected.

Aspects of the technical solutions described herein facilitate generating scenarios including impacts to a performance of entities using a machine learning model. The machine learning model receives at least a data set and a criteria received from a client device associated with a first entity of the structure of entities as inputs. For example, aspects of the technical solutions described herein can generate, based at least on a data set and a criteria defining a change in the data set, a scenario including impacts to a performance of the structure of entities. The data set is associated with resource utilization of a structure of entities including nodes, the nodes to define related entities of the structure of entities using one or more parameters correlated to the data set. It can be difficult for structures of entities to generate scenarios including impacts to a performance of the structure of entities that take into account all of the nodes within the structure of entities. Structures of entities are generally unaware of how a change in resource utilization for an entity of the structure of entities could affect other nodes or entities within the structure of entities. Additionally, various entities within the structure of entities do not have all of the necessary information to make an informed decision about a change in resource utilization. Consequently, entities within structures of entities frequently make uninformed decisions about changes in resource utilization with little to no input from other entities in the structure of entities.

These uninformed decisions can cause a negative impact to a performance of the structure of entities. A support entity within the structure of entities might be understaffed, which causes other entities within the structure of entities to be delayed in a performance of their responsibilities while they wait to receive the support they need. An entity within the structure of entities might hire more new employees than that entity can afford to have on payroll, which could cause another entity in the structure of entities to lose an amount of fiscal support. Due to the complex relationships (e.g., nodes) between entities of the structure of entities, it can be difficult for the structure of entities to fully and accurately quantify the effects of a proposed change in resource utilization. These technical difficulties can result in suboptimal or even negative performance for the structure of entities.

Further, attempts to quantify all of the nodes within the structure of entities, or attempts to quantify an impact on a performance of the structure of entities caused by a change in resource utilization can be computationally expensive. Here, “computationally expensive” indicates that the computational costs required to quantify the notes or the one or more impacts of the change in resource utilization being above certain predetermined thresholds. Computational costs can include factors such as network bandwidth, time, memory, electric power, and processing power etc. The computational cost can also be indicated in terms of computations being performed, for example, the number of floating point operations (FLOPs), and/or as number of multiply-and-accumulate operations (MACs or MACCs).

These impact predictions cause latency, error, traffic congestion, or delay across a system including the client devices and data processing systems due to the size of the data sets, variety of formats, and intricacies of the data sets. Furthermore, impact predictions can be prone to error and are not easily extensible to new structures of entities. Due to the complex nodes within the structure of entities and the scale of heterogeneous computing systems, it can be challenging to predict impact scenarios for different structures of entities without excessive latency, inaccuracy, or generating erroneous computing actions. These technical challenges further prevent one or more client devices associated with a node of the structure of entities from providing input that would increase the accuracy of the predicted impact scenario due to extensive network traffic and reduced throughput, thereby affecting the efficiency of the system overall.

Technical solutions are provided herein to address such technical challenges. The technical solutions facilitate use of machine learning models to generate scenarios quantifying impacts to a performance of the structure of entities based at least on a data set and a criteria defining a change in the data set from a client device associated with a first entity of the structure of entities. The technical solutions described herein facilitate determining that the one or more impacts of a scenario (e.g., the effects of a proposed change in resource utilization) are above a threshold. Furthermore, the technical solutions described herein facilitate collaboration among entities within the structure of entities by allowing inputs from multiple different entities within the structure of entities. The technical solutions described herein facilitate analysis of nodes of the structure of entities to determine previously unknown entities of the structure of entities that could be impacted by a proposed change in resource utilization. The technical solutions described herein facilitate training the machine learning models using feature encoding and a set of previously constructed scenarios to provide robust analysis of proposed changes in resource utilization to determine impacts on a performance of the structure of entities. The technical solutions described herein can further reduce uncertainty and lack of knowledge compared to systems which do not use this predictive model, by enabling the machine learning models to process inputs according to the input feature encoding and produce outputs associated with impacts to a performance of the structure of entities. Thus, by predicting impacts on a performance of a structure of entities using machine learning model(s), the technical solutions described herein reduce computational cost (e.g., network bandwidth, time, memory, electric power, and processing power etc.) associated with generating impact scenarios compared to previous impact prediction systems. Accordingly, the technical solutions described herein are rooted in computing technology, and provide improvements to computing technology, particularly systems that predict impacts to a performance of a structure of entities based on a change of resource utilization.

At least one aspect of the technical solutions described herein is directed to a system. The system includes one or more processors, coupled with memory. The one or more processors receives a data set including resource utilization of a structure of entities, wherein the structure of entities comprises nodes, the nodes to define related entities of the structure of entities using one or more parameters correlated to the data set. The one or more processors receives criteria defining a change in the data set from a client device associated with a first entity of the structure of entities. The one or more processors generates, using the criteria and the data set as inputs to a machine learning model, a scenario comprising impacts to a performance of the structure of entities. The one or more processors determines that one or more of the impacts are above a threshold impact for a first node of the nodes. The one or more processors executes, responsive to the one or more impacts being above the threshold impact, an action associated with the scenario for the structure of entities to control the impact on the first node.

In some aspects of the technical solutions described herein, the one or more processors receives, from the first node, responsive to presenting the scenario to the first node, additional criteria from the client device associated with the first node. The one or more processors generates a second scenario by providing the criteria, the data set, and the additional criteria as inputs to the machine learning model. The one or more processors executes a second action associated with the second scenario for the structure of entities.

In some aspects of the technical solutions described herein, the one or more processors generates the scenario comprising a first plurality of scenarios by providing the criteria and the data set as inputs to the machine learning model. The one or more processors determines that the one or more impacts are above the threshold impact for the first node for each scenario for the first plurality of scenarios. The one or more processors presents each scenario of the first plurality of scenarios that are above the threshold impact to the first node via the client devices associated with the first node.

In some aspects of the technical solutions described herein, the one or more processors generates a plurality of second scenarios responsive to presenting the scenario to the first node, by providing the criteria, the data set, and additional criteria from the first node as inputs to the machine learning model. The one or more processors receives, from the first entity, a selection of the scenario from the plurality of second scenarios.

In some aspects of the technical solutions described herein, the one or more processors generates a plurality of scenarios comprising the one or more impacts for each scenario of the plurality of scenarios by providing the criteria and the data set as inputs to the machine learning model. The one or more processors determines a corresponding node of the nodes for each scenario of the plurality of scenarios with the one or more impacts above the threshold impact. The one or more processors presents each scenario of the plurality of scenarios to its corresponding node via client devices associated with each corresponding node. The one or more processors receives, from the client devices associated with each corresponding node, a selection of the scenario from the plurality of scenarios. The one or more processors executes the action associated with the scenario for the structure of entities based on the selected scenario.

In some aspects of the technical solutions described herein, the one or more processors identifies a subset of the data set based on the criteria. The one or more processors provides the subset of the data set as input to the machine learning model to determine the one or more impacts.

In some aspects of the technical solutions described herein, the one or more processors presents a confirmation of the action to the first entity. The one or more processors executes the action responsive to receiving an indication confirming execution of the action from the first entity.

In some aspects of the technical solutions described herein, the structure of entities comprises entities related to one or more of: time entry, payroll, human resources, compensation, benefits, real estate, or finance.

In some aspects of the technical solutions described herein, the one or more processors selects the action from a list of predetermined actions associated with the one or more impacts.

In some aspects of the technical solutions described herein, the first node includes the first entity.

In some aspects of the technical solutions described herein, the one or more processors receiving the criteria defining the change in the data set from the client device associated with the first entity of the structure of entities comprises the one or more processors to determine a suggestion of the criteria using historical data associated with the first entity as input to a second machine learning model using natural language learning. The one or more processors receiving the criteria defining the change in the data set from the client device associated with the first entity of the structure of entities further comprises the one or more processors to present, via the client device associated with the first entity, the suggestion of the criteria. The one or more processors receiving the criteria defining the change in the data set from the client device associated with the first entity of the structure of entities further comprises the one or more processors to receive a selection of the criteria from the suggestion of the criteria.

At least one aspect of the technical solution described herein is directed to a method. The method includes receiving, by one or more processors coupled to memory, from a client device associated with a structure of entities a data set including resource utilization of the structure of entities, wherein the structure of entities comprises nodes, the nodes to define related entities of the structure of entities using one or more parameters correlated to the data set. The method includes receiving, by the one or more processors, criteria defining a change in the data set from a client device associated with a first entity of the structure of entities. The method includes generating, by the one or more processors, a scenario comprising impacts to a performance of the structure of entities by providing the criteria and the data set as inputs to a machine learning model. The method includes determining, by the one or more processors, that the one or more of the impacts are above a threshold impact for a first node of the nodes. The method includes executing, by the one or more processors, an action associated with the scenario for the structure of entities responsive to the one or more impacts being above the threshold impact.

In some aspects of the technical solutions described herein, the method includes presenting, by the one or more processors, the scenario comprising the one or more impacts to the first node via client devices associated with the first node.

In some aspects of the technical solutions described herein, the method includes receiving, by the one or more processors, from the first node, responsive to presenting the scenario to the first node, additional criteria from client devices associated with the first node. The method includes generating, by the one or more processors, a second scenario by providing the criteria, the data set, and the additional criteria as inputs to the machine learning model. The method includes executing, by the one or more processors, a second action associated with the second scenario for the structure of entities.

In some aspects of the technical solutions described herein, the method includes generating, by the one or more processors, the scenario comprising a first plurality of scenarios by providing the criteria and the data set as inputs to the machine learning model. The method includes determining, by the one or more processors, that the one or more impacts are above a threshold impact for the first node for each scenario of the first plurality of scenarios. The method includes presenting, by the one or more processors, each scenario of the first plurality of scenarios that are above the threshold impact to the first node via client devices associated with the first node.

In some aspects of the technical solutions described herein, the method includes generating, by the one or more processors, a plurality of second scenarios, responsive to presenting the scenario to the first node, by providing the criteria, the data set, and additional criteria from the first node as inputs to the machine learning model. The method includes receiving, by the one or more processors, from the first entity, a selection of the scenario from the plurality of second scenarios.

In some aspects of the technical solutions described herein, the method includes generating, by the one or more processors, a plurality of scenarios comprising the one or more impacts for each scenario of the plurality of scenarios by providing the criteria and the data set as inputs to the machine learning model. The method includes determining, by the one or more processors, a corresponding node of the nodes for each scenario of the plurality of scenarios with the one or more impacts above the threshold impact. The method includes presenting, by the one or more processors, each scenario of the plurality of scenarios to its corresponding node via client devices associated with each corresponding node. The method includes receiving, by the one or more processors, from the client devices associated with each corresponding node, a selection of the scenario from the plurality of scenarios. The method includes executing the action associated with the scenario for the structure of entities based on the selected scenario.

In some aspects of the technical solutions described herein, the method includes presenting a confirmation of the action to the first entity. The method includes executing the action responsive to receiving an indication confirming execution of the action from the first entity.

At least one aspect of the technical solutions described here is directed to a non-transitory computer-readable medium. The non-transitory computer readable medium includes instructions embodied thereon to cause one or more processors to receive, from a client device associated with a structure of entities, a data set associated with a structure of entities comprising nodes, the nodes to define related entities of the structure of entities using one or more parameters correlated to the data set. The instructions cause the processor to receive criteria defining a change in the data set from a client device associated with a first entity of the structure of entities. The instructions cause the processor to generate a scenario comprising impacts to a performance of the structure of entities by providing the criteria and the data set as inputs to a machine learning model. The instructions cause the processor to execute an action associated with the scenario for the structure of entities.

In some embodiments, the instructions cause the processor to determine that the one or more impacts are above a threshold impact for a first node of the nodes. The instructions cause the processor to present the scenario comprising the one or more impacts to the first node via client devices associated with the first node.

In some aspects of the technical solutions described herein, the instructions cause the processor to receive, from the first node, responsive to presenting the scenario to the first node, additional criteria from the client devices associated with the first node. The instructions cause the processor to generate a second scenario by providing the criteria, the data set, and the additional criteria as inputs to the machine learning model. The instructions cause the processor to execute a second action associated with the second scenario for the structure of entities.

These and other aspects and implementations are discussed in detail below. The foregoing information and the following detailed description include illustrative examples of various aspects and implementations to provide an overview or framework for understanding the nature and character of the claimed aspects and implementations. The drawings provide illustration and a further understanding of the various aspects and implementations and are incorporated in and constitute a part of this specification. The foregoing and following detailed description and drawings include illustrative examples that should not be considered limiting.

### BRIEF DESCRIPTION OF THE DRAWINGS

Aspects of the technical solutions are described in the detailed description which follows, in reference to the noted plurality of drawings by way of non-limiting examples of exemplary embodiments of the technical solutions described herein.

FIG. 1 depicts an example system of prediction of global impacts.

FIG. 2 depicts an example method for prediction of global impacts.

FIG. 3 depicts an example method for prediction of global impacts.

FIG. 4 depicts an example method for prediction of global impacts.

FIG. 5 depicts an example method for prediction of global impacts.

FIG. 6 depicts an illustrative architecture of a computing system implemented in embodiments of the technical solutions described herein.

FIG. 7 shows an exemplary cloud computing environment in accordance with aspects of the technical solutions described herein.

### DETAILED DESCRIPTION OF ASPECTS OF THE INVENTION

Following below are more detailed descriptions of various concepts related to, and implementations of, methods, apparatuses, and systems to generate impact scenarios via machine learning models. The various concepts introduced above and discussed in greater detail below can be implemented in any of numerous ways.

The technical solutions described herein describe a system, method, and computer readable medium to predict impact scenarios for a structure of entities based on a proposed change in resource utilization of the structure of entities. Aspects of the technical solutions described herein are generally directed to generating scenarios involving impacts to a performance of a structure of entities, and selecting and executing actions based at least in part on the generated impact scenarios. For example, aspects of the technical solutions described herein receive, from a client device associated with a structure of entities, a data set including resource utilization of the structure of entities, wherein the structure of entities includes nodes. Aspects described herein generate a scenario including impacts to a performance of the structure of entities by providing the data set as inputs to a machine learning model. The data set can be a real time data set. Actions can be identified and executed according to the generated scenarios. It can be challenging to correctly and efficiently allocate resources among entities within a structure due to a lack of comprehensive understanding of the relationships between entities within the structure of entities (e.g., a lack of a comprehensive understanding of nodes within the structure of entities). A technical challenge exists where decisions involving potential resource utilization are made without a uniform understanding among entities within the structure about how the potential resource utilization impacts performance of entities within the structure. Additionally, another technical challenge exists where decisions involving resource utilization are made without a uniform understanding of how the potential resource utilization impacts a performance of one or more nodes of one or more entities within a structure. This lack of uniform understanding can lead to a structure of entities making decisions regarding resource utilization that can be inefficient or even harmful to the structure of entities. Evaluating potential impacts on the structure of entities, or nodes within the structure of entities, of potential resource utilization can require manual computation for each of the impacted nodes within the structure of entities. This can lead to scenarios where decisions involving potential resource utilization are made with an incomplete, non-uniform, or nonexistent, understanding of how the potential resource utilization impacts the structure of entities, or one or more nodes within the structure of entities.

For example, an entity within a structure implements a change in resource utilization within the entity. The entity does not have the ability to quantify how the change in resource utilization affects nodes between entities within the structure of entities. The entity may only have the technical capability of quantifying the effect of the change in resource utilization has on itself. Consequently, one or more nodes within the structure no longer have sufficient resources to sustain operations within the structure. Due to these technical challenges, overall performance within the structure is negatively impacted.

Aspects of technical solutions described herein predict future impacts on a structure based on received data involving resource utilization of one or more entities. Furthermore, using the received data, the technical solutions described herein analyze how changes in resource utilization impacts not only an entity within the structure, but also nodes defining related entities within the structure. Upon a receipt of a criteria defining a change in the data set, technical solutions described herein generate an impact scenario quantifying impacts to the performance of the structure of entities. By generating impact scenarios, technical solutions described herein execute an action associated with the scenario. The action can control an impact on the first node.

The technical solutions described herein facilitate collaboration among entities within a structure of entities. By assigning inputs to one or more entities within the structure of entities, the technical solutions described herein create robust prediction models by analyzing how resource utilization affects one or more nodes within the structure of entities. By requesting approvals from one or more entities within the structure of entities, the technical solutions described herein prevent the structure of entities from executing one or more actions that would negatively impact the performance of the structure of entities.

Thus, by utilizing a variety of inputs from a variety of devices, the system can solve the technical problem of making uninformed, non-uniform decisions regarding the one or more impacts of resource utilization. This can allow structures of entities to maximize the utility of their resource utilization and operate in a more cohesive manner.

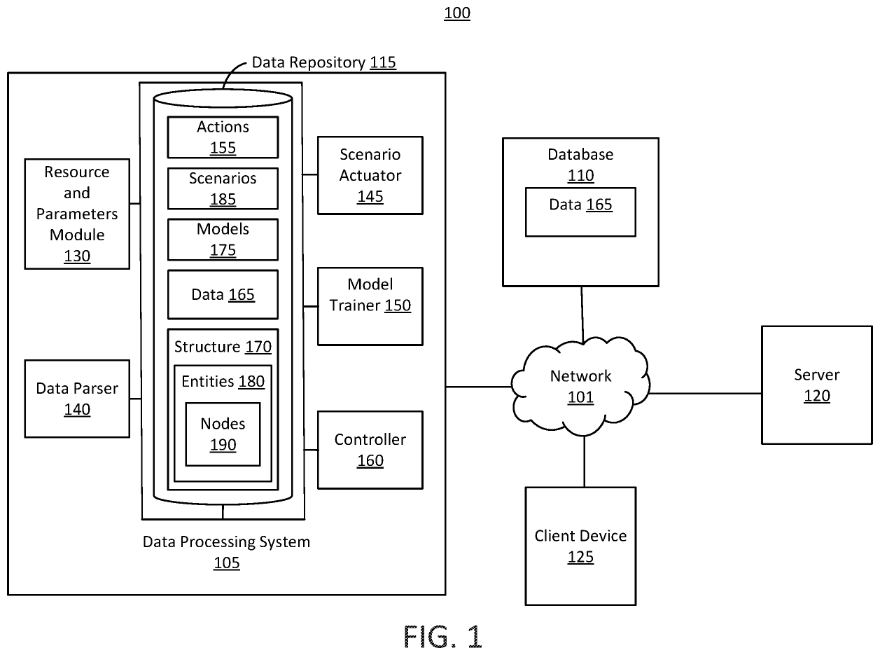

FIG. 1 depicts an example system 100 that facilitates predicting impacts on a performance of an entity according to one or more aspects of the technical solutions described herein. The system 100 includes a data processing system 105, a database 110, a server 120, one or more of clients 125 (sometimes hereinafter referred to as the client 125, the client device(s) 125, or the client service(s) 125), and a network 101. The data processing system 105 includes a data repository 115, a resource and parameters module 130, a data parser 140, a scenario actuator 145, a model trainer 150, or a controller 160. The resource and parameters module 130, the data parser 140, the scenario actuator 145, the model trainer 150, the controller 160, and the data repository 115 each communicates with the database 110 or the client devices 125 via the network 101.

The data processing system 105 can interface with, communicate with, or otherwise receive or provide information with one or more of the client device 125, the server 120, or the database 110. The data processing system 105 can include at least one logic device such as a server 120. The server 120 can be a computing device having a processor to communicate via a network 101. The data processing system 105 can include or interface with at least one server 120. The server 120 can be a computation resource, server, processor or memory. For example, the data processing system 105 can include a plurality of computation resources or processors. The server 120 can facilitate communications between the data processing system 105, the database 110, or the client device via the network 101.

The network 101 can be a wireless or wired connection for enabling the data processing system 105 to store, transmit, receive, or display information to identify, extract, and map a data set from a first type to a second type. The data processing system 105 can communicate with internal subcomponents (described herein), or external components (e.g., the server 120, the database 110, or the client device 125, among others) via the network 101. The data processing system 105 can, for example, store data about the system in the data repository 115. The data processing system 105 can, for example, receive the data 165 transmitted from the database 110.

The network can include a hardwired connection (e.g., copper wire or fiber optics) or a wireless connection (e.g., wide area network (WAN), controller area network (CAN), local area network (LAN), or personal area network (PAN)). For example, the network 101 can include WiFi, Bluetooth, BLE, or other communication protocols for transferring over networks as described herein.

The data 165 (hereinafter referred to as data 165 or data set(s) 165) include a plurality of values. The data 165 can be stored in the database 110 or the data repository 115. The values can be alpha-numeric. In some cases, the values are displayable on a screen, such as that of the client device 125, or the data processing system 105. For example, the data 165 can include strings such as “First Name” or “Earnings” or “130,000” or “0.60.” The data 165 can include auditory values, such as a sound or a vocal recording. The data 165 can include colored or color coded-values. The data 165 can include time-related values, such as a current time, elapsed time, or clock-in time, among others. The data 165 can include images. The values of the data 165 include any combination of values. For example, a first value of the data 165 includes an image and a string, and a second value of the data 165 includes an auditory value. The values of the data 165 can relate to each other. The data 165 can be associated with a resource utilization of a structure 170 of entities 180. The data 165 can be associated with a structure 170 of entities 180 including nodes 190, the nodes 190 to define related entities of the structure 170 of entities 180 using one or more parameters correlated to the data 165. Some values of the data 165 can be null or zero values.

The data 165 include different attributes, such as file type, structure type, number of entities within the structure, nodes for the entities within the structure, or other such attributes. The data 165 are included in, denoted by, or transmitted as an electronic file type. Examples of electronic file types include comma separated values (CSV), excel files (XLS or XLSM), or data interchange format (DIF), JavaScript Object Notation (JSON), among others. The data 165 can be associated with or stored as a file type. The file determines or relates to data structures associated with the data 165. In some technical solutions described herein, the data 165 are encrypted by the database 110, such as by Advanced Encryption Standard (AES), Rivest-Shamir-Adleman (RSA), or another encryption standard. The data 165 can be unencrypted by the database 110, or by another system enabled for access to the data 165, such as the data processing system 105. In some aspects of the technical solutions described herein, one or more client devices requests access to the data 165 or requests data 165 itself from the database 110 via the data processing system 105 or through another computing system or the client device 125 directly. The data set 165 can be received from a client device 125 associated with the structure 170 of entities 180.

The data repository 115 is any memory, storage, or cache for storing information or data structures of the system 100. The data repository 115 allows data 165 to be accessed by any components of the system 100, such as by communication methods described herein. The data repository 115 contains at least models 175, scenarios 185, data 165, actions 155, information about structures 170 of entities 180, and nodes 190, among others. The information in the data repository 115 is stored in any kind of memory, such as a cloud or hard drive. The data repository 115 includes, for example, random access memory (RAM), dynamic random access memory (DRAM), static random access memory (SRAM), error correcting code (ECC), read only memory (ROM), programmable read only memory (PROM), or electrically erasable read only memory (EEPROM). The information or data structures (e.g., tables, lists, or spreadsheets) contained within the data repository 115 are dynamic and change periodically (e.g., daily or every millisecond); via information from the server (e.g., through batch processing, real-time streaming, webhooks, scheduled cron jobs, incremental updates, database triggers, API requests, or version control systems, among others); via an input from a user (e.g., a user operating the client device 125); via information from the database 110, or the client device 125, transmitted through the network 101; via inputs from subcomponents of the data processing system 105, the models 175, the scenarios 185, the actions 155, the structures 170, the entities 180, or the nodes 190), or via an external update to the system 100. For example, the models 175 within the data repository 115 change or are updated responsive to an indication from the model trainer 150.

The data repository 115 maintains information for the structure 170, entities 180, or nodes 190. The structure 170 is a company or organization. Entities 180 are various organizations within the structure 170. Nodes 190 define relationships within entities 180 within the structure 170. In an illustrative example, the structure 170 is a for profit company. The structure 170 includes many entities 180. The entities 180 are organizations within the structure 170 such as stakeholders, vice presidents, the head of accounting, the accounting department, the head of finance, the finance department, the head of technology or the technology department. Nodes 190 define relationships between entities 180 within the structure 170, such as, for example, how the salaries of the accounting department affect the salaries of the human resource department, how the number of employees in the information technology department affects vacation time available in the human resource department, how a vice president's bonus affects the salaries of the finance department, or how the number of employees in the technology department affects the people hours used by the information technology support department. The structure 170 of entities 180 includes entities 180 related to one or more of: time entry, payroll, human resources, compensation, benefits, real estate, finance, technology, information technology, information technology support, accounting, finance, or sales.

The client device 125 is or includes any computing device such as a laptop, a desktop computer, a smart phone, a tablet, etc. A user may operate, display, or otherwise execute an application via the client device 125. The client device 125 can be coupled with storage or memory. In some aspects of the technical solutions described herein, the client device 125 is operated by a user associated with an organization to perform various tasks associated with the organization. The client device 125 executes one or more applications. The application is any platform for performing the various tasks associated with the organization, such as low-code platform, no-code platform, software-as-a-service platform (SaaS), web application, web browser, desktop application, among others. In some aspects of the technical solutions described herein, the application is or includes an electronic transaction system for maintaining a data set to perform a transaction.

The data processing system 105 interfaces with, communicates with, or otherwise receives or provides information with the database 110, the client device 125, among others. The data processing system 105 includes or interfaces with at least one logic device such as a server. The server is a computing device having a processor to communicate via the network 101. The data processing system 105 includes or interfaces with at least one server. The server is a computation resource, server, processor, or memory. For example, the data processing system 105 includes a plurality of computation resources or processors. The server facilitates communications between the data processing system 105, the database 110, and the client device 125 via the network 101.

The parameters and resource module 130 receives a data set 165 from the database 110 that correlates to the query received by the parameters and resource module 130. The data set 165 is associated with resource utilization of a structure 170 and entities 180. The data set 165 comprises nodes 190. The nodes 190 define related entities of the structure 170 of entities using one or more parameters correlated to the data set 165. The data parser 140 receives a criteria defining a change in the data set 165 from a client device 125 associated with a first entity of the structure 170 of entities 180. The scenario actuator 145 generates a scenario 185 including impacts to a performance of the structure 170 of entities 180 by providing the criteria and the data set 165 as inputs to a model trainer 150. The model trainer 150 trains one or more machine learning models 175 to perform the functionalities described herein. The scenario actuator 145 determines that one or impacts are above a threshold impact for a first node of the nodes 190. The controller 160 presents the scenario 185 including the one or more impacts to the first node via a client device 125 associated with the first node. The controller 160 executes, responsive to the one or more impacts being above the threshold impact an action 155 associated with the scenario 185 for the structure 170 of entities 180 to control an impact on the first node. The impact on the first node can be one of the impacts of the scenario 185 generated by the scenario actuator 145. The data set 165 includes one or more of real-time data or historical data.

The resource and parameters module 130, the data parser 140, the scenario actuator 145, the model trainer 150, or the controller 160 can each include at least one processing unit or other logic device such as programmable logic array engine, or module configured to communicate with the data repository 115 or database 110. The resource and parameters module 130, the data parser 140, the scenario actuator 145, the model trainer 150, or the controller 160 can be separate components, separate microdevices, a single component, or part of the data processing system 105. The system 100 and its components, such as the data processing system 105, includes hardware elements, such as one or more processors, logic devices, or circuits.

The data processing system 105 includes one or more microservices configured to be executed by the one or more processors of the data processing system 105. Each microservice communicates with other microservices to perform a function. In some embodiments, each microservice is located on a separate server or one or more microservices are located on the same server. In some aspects of the technical solutions described herein, each microservice corresponds to a processor of the data processing system 105 or one or more microservices has their functionalities executed by the same processors. In some aspects of the technical solutions described herein, subcomponents of the data processing system 105, such as the resource and parameters module 130, the data parser 140, the scenario actuator 145, the model trainer 150, or the controller 160, can each be or include a microservice. In some embodiments, the microservices can operate or execute on an application. For example, in some aspects of the technical solutions described herein, the operations of the system 100 can operate on or be performed by an application operating on the client device 125.

The data processing system 105 includes a resource and parameters module 130 designed, constructed, and operational to receive, identify, obtain data sets 165 from the data repository 115. The data set 165 is associated with resource utilization of a structure 170 of entities 180 including nodes 190. The resource and parameters module 130 identifies parameters correlated to the data set 165. Parameters define what is included in the data set 165. The resource and parameters module 130 communicates the data set 165 and the parameters to the data parser 140. The resource and parameters module 130 analyzes the data set 165 to determine the parameters correlated to the data set 165. For example, upon receipt of the data set 165, the resource and parameters module 130 analyzes the data set 165 and determines the data set 165 contains multiple types of data, including the total number of employees employed by the structure 170 of entities 180, the salary of each employee, the sum of the employees' salary, the number of employees within each entity 180 of the structure 170 of entities 180, or the number of nodes between one or more entities 180 of the structure 170 of entities 180.

In some embodiments, the resource and parameters module 130 parses the data set 165 to identify one or more nodes 190 between entities 180 of the structure 170 of entities (e.g., the resource and parameters module quantifies relationships between entities 180 of the structure 170 of entities 180). The resource and parameters module parses the data set 165 and one or more parameters of the data set 165 to identify one or more parameters of a first entity of the structure 170 of entities 180 that affect a second entity of the structure 170 of entities 180. The resource and parameters module identifies one or more nodes 190 by determining one or more parameters that impact one or more entities 180 of the structure 170 of entities 180.

The data processing system 105 includes a data parser 140 designed, constructed, and operational to receive a criteria defining a change in the data set 165 from a client device 125 associated with a first entity of the structure 170 of entities 180. The data parser 140 defines a change in the data set 165 by comparing the data set 165 received from the resource and parameters module 130 with the criteria received from the client device 125 associated with the first entity of the structure 170 of entities 180 or by comparing the parameters received from the resource and parameters module 130 with the criteria received from the client device 125. The criteria received from the client device 125 is a proposed change in resource utilization for the structure 170 of entities 180. The proposed change in resource utilization is an increase or decrease of the current resource utilization of the structure 170. The data parser 140 identifies a subset of the data set 165 based on the criteria received from the client device 125 associated with a first entity of the structure 170 of entities 180. The subset is data from one or more nodes in the data set 165. The data parser 140 communicates the criteria, the data set 165, or the subset of the data to the scenario actuator 145. The data parser 140 defines the criteria by determining a change in one or more parameters correlated to the data set 165.

The data parser 140 receives additional criteria from the client device 125 associated with the first node. The receipt of additional criteria can be responsive to the controller 160 presenting the scenario 185 to the first node. The data parser 140 can receive additional criteria from one or more client devices 125 associated with one or more nodes 190 of the structure 170 of entities 180. The data parser 140 can receive an overriding criteria from the client device 125 associated with the first node. The overriding criteria can be provided along with the data set 165 by the scenario actuator 145 to the model 175 as inputs. The data parser 140 can receive additional criteria from one or more nodes 190 of the plurality of nodes responsive to the controller 160 assigning input requirements to the one or more nodes 190 of the plurality of nodes. Thus, the criteria received from one or more client devices 125 by the data parser 140 can be responsive to commands from the controller 160, or additional input from the client device 125 without any assignment from the data processing system 105

The scenarios 185 are one or more scenarios generated by the scenario actuator 145 including impacts to a performance of the structure 170 of entities 180 based on the criteria and data set 165 received by the scenario actuator 145. For example, the scenario 185 is a potential impact to a performance of the structure 170 of entities 180 which is likely to be caused by a criteria defining a change in the data set 165 received by the scenario actuator 145 from a client device 125 associated with a first entity of the structure 170 of entities 180. Here, the criteria received from the client device 125 defines a proposed change in resource utilization for the structure 170 of entities 180. The scenario 185 generated by the scenario actuator 145 quantifies an impact that the change in resource utilization could have on the performance of the structure 170 of entities 180. The scenario 185 can include one or more of: one or more impacts to the performance of the structure 170 of entities 180, one or more impacts to one or more entities within the structure 170 of entities 180, or one or more impacts to one or more nodes 190 between entities within the structure 170 of entities 180.

The data processing system 105 includes a scenario actuator 145 designed, constructed, and operational to generate a scenario 185 including impacts to a performance of the structure 170 of entities 180 by providing the criteria and the data set 165 as inputs to the model trainer 150. The scenario actuator 145 interfaces with the resource and parameters module 130, the data parser 140, the model trainer 150, the controller 160, or the data repository 115, among others. The scenario actuator 145 receives the data set 165 from the resource and parameters module 130 or the data repository 115. The scenario actuator 145 receives one or more criteria from the data parser 140. The scenario actuator 145 provides one or more of the data set 165 or the criteria as input to a model 175. The scenario actuator 145 can provide one or more of the data set 165 or the criteria as inputs to the model trainer 150. The scenario actuator 145 can provide the parameters of the data set 165 to the model 175 or the model trainer 150. The scenario actuator 145 can provide a subset of the data set 165 as input to the model 175 to determine the one or more impacts.

The scenario actuator 145 can select a model 175 of the plurality of models stored in the data repository 115 by analyzing the parameters of the data set 165 and choosing the model 175 according to the parameters or the criteria. The scenario actuator 145 can provide multiple criteria as inputs to the model 175 or the model trainer 150. The scenario actuator 145 stores the one or more scenarios 185 output by the model 175 in the data repository 115.

The scenario actuator 145 can generate a second scenario by providing the data set 165, the criteria, and additional criteria received from the data parser 140 as inputs to the model 175. The scenario actuator 145 can generate a scenario 185 including a first plurality of scenarios by providing the criteria and the data set 165 as inputs to the model 175. The scenario actuator 145 can generate a plurality of second scenarios, responsive to the controller 160 presenting the scenario 185 to the first node, by providing the criteria, the data set 165, and additional criteria from the first node as inputs to the model 175. The scenario actuator 145 can generate a plurality of scenarios including the one or more impacts for each scenario of the plurality of scenarios by providing the criteria and the data set 165 as inputs to the model 175.

In an illustrative example, the scenario 185 generated by the scenario actuator 145 includes a first impact to a first fiscal performance of a first of the structure 170 of entities 180 (e.g., a financial impact on an engineering company). The scenario 185 includes a second impact to a second fiscal performance of a second entity of the structure 170 of entities 180 (e.g., a financial impact on a design team within the engineering company). The scenario 185 includes a third impact to a third fiscal performance to a third entity of the structure 170 of entities 180 (e.g., a financial impact on a regulatory team within the engineering company). The first node is the relationship between the first entity and the second entity (e.g., the relationship between the engineering company as a whole and the design team within the engineering company). A second node is the relationship between the first entity and the third entity (e.g., the relationship between the engineering company as a whole and the regulatory team within the engineering company). A third node is the relationship between the second entity and the third entity (e.g., the relationship between the design team within the engineering company and the regulatory team within the engineering company). The threshold impact can be a percentage increase in revenue.

In a first embodiment of the above illustrative example (e.g., paragraph [0065]), the controller 160 can determine that a first impact on the first node, a second impact on the second node, and a third impact on the third node all must be above the threshold impact. In a second embodiment of the above illustrative example (e.g., paragraph [0065]), the controller 160 can determine that the first impact on the first node and the second impact on the second node must be above the threshold impact, but the controller 160 can determine that the third impact on the third node does not need to be above the threshold impact. In a third embodiment of the above illustrated example (e.g., paragraph [0065]), the controller 160 can determine that the threshold impact is the same for the first impact, the second impact, and the third impact. In a fourth embodiment of the above illustrated example (e.g., paragraph [0065]), the controller 160 can determine a first threshold impact for the first impact, a second threshold impact for the second impact, and a third threshold impact for the third impact. The above illustrated example (e.g., paragraph [0065]) and the foregoing embodiments demonstrate that the controller 160 is highly adaptive and can determine a plurality of impacts to a plurality of nodes according to a plurality of threshold impacts. Accordingly, the data processing system 105 addresses the technical challenges of identifying nodes 190 within the structure 170 of entities 180 and quantifying how scenarios 180 can impact one or more of the nodes.

The scenario actuator 145 generates scenarios 185 including impacts to a performance of the structure 170 of entities 180 using one or more models 175. The models 175 include one or more machine learning models, algorithms, or ensembles of machine learning models to determine the scenarios 185 based at least on the data set 165 and criteria received from a client device 125 associated with a first entity of the structure 170 of entities 180. The models 175 accept inputs to determine an output of the scenario 185. For example, the model 175 uses the training data set and a criteria received from a client device 125 to generate the scenario 185. The scenarios 185 quantify impacts to a performance of the structure 170 of entities 180. The scenario 185 can quantify impacts to the performance of the structure 170 of entities 180 as a whole, to the performance of one or more entities within the structure 170 of entities 180.

In some aspects, the models 175 (hereinafter referred to as model(s) 175, machine learning model(s) 175, trained model(s) 175, or retrained model(s) 175) include one or more neural networks, decision-making models, linear regression models, natural language models, random forests, classification models, reinforcement learning models, clustering models, neighbor models, decision trees, probabilistic models, classifier models, or other such models. For example, the models 175 include natural language processing (e.g., support vector machine (SVM), Bag of Words, Counter Vector, Word2Vec, k-nearest neighbors (KNN) classification, long short erm memory (LSTM)), object detection and image identification models (e.g., mask region-based convolutional neural network (R-CNN), CNN, single shot detector (SSD), deep learning CNN with Modified National Institute of Standards and Technology (MNIST), RNN based long short term memory (LSTM), Hidden Markov Models, You Only Look Once (YOLO), LayoutLM) (classification ad clustering models (e.g., random forest, XGBBoost, k-means clustering, DBScan, isolation forests, segmented regression, sum of subsets 0/1 Knapsack, Backtracking, Time series, transferable contextual bandit) or other models such as named entity recognition, term frequency-inverse document frequency (TF-IDF), stochastic gradient descent, Naïve Bayes Classifier, cosine similarity, multi-layer perceptron, sentence transformer, data parser, conditional random field model, Bidirectional Encoder Representations from Transformers (BERT), among others. It should be understood that this listing of machine learning models is exemplary and is not construed to be exhaustive or limiting.

The model 175 accepts the data set 165 and one or more criteria defining a change to the data set 165 from a client device 125 associated with a first entity of the structure 170 of entities 180. For example, the scenario actuator 145 generates a scenario 185 by providing the data set 165 and the criteria to the model 175. The models 175 can accept inputs in addition to or instead of the data set 165 and the criteria. Such inputs include an additional criteria from client device 125, an additional criteria from an additional client device, multiple additional criteria from another client device, multiple additional criteria from multiple client devices, a time associated with the criteria (e.g., a time of receipt of the criteria by the data processing system 105 or a time of transmittal of the criteria by the client device 125), historical information (e.g., last receipt of a criteria from a client device 125, a listing of the data set 165 that the resource and parameters module 130 has received, parameters of the data set 165 that the resource and parameters module 130 has received, prior outcomes determined by the data processing system 105 or the models 175, among others), publicly or privately available data (e.g., databases or references from outside entities such as governments, non-profits, educational institutions, or data aggregated by the data processing system 105, the client device 125, or the database 110), user inputs, among others. The model 175 generates the scenarios 185 based on such input.

In some aspects of the technical solutions described herein, modifying inputs to one or more of the models 175 can include efficient feature encoding. Efficient feature encoding refers to generating inputs for the model 175 using criteria received from a client device 125 associated with a first entity of the structure 170 of entities 180. Efficient feature encoding reduces time and computational power for the model 175 to process inputs to produce outputs (such as the scenarios 185) by providing inputs corresponding to a format based on the scenarios 185. In this manner, the model 175 receives structured inputs based on the criteria to streamline training of the model 175, generating scenarios 185 by the model 175, among others.

The data processing system 105 includes a model trainer 150 designed, constructed, and operational to train, identify, or operate the models 175. The model trainer 150 trains the models 175 by receiving one or more of input from client devices 125, the data set 165, or criteria received from a client device 125 associated with a first entity of the structure 170 of entities 180, among others. The model trainer 150 identifies models 175 for use by other subcomponents of the data processing system 105. The model trainer 150 stores or modifies the models 175 in the data repository 115.

The model trainer 150 trains the models 175. The model trainer 150 establishes or generates the models 175 using one or more of the data set 165, criteria received from a client device 125 associated with a first entity of the structure 170 of entities 180, additional input from client devices 125 associated with at least one entity of the structure 170 of entities 180, or one or more parameters correlated to the data set 165. The model trainer 150 uses the training data set constructed from data acquired from or associated with a multitude of client devices 125, to train the models 175 for use with the client device 125. For example, the model trainer 150 trains the models 175 using data associated with the structure 170, entities 180, or nodes 190 associated with one or more client devices 125. In some embodiments, the model trainer 150 trains the models 175 using a training set constructed from data associated with the client device 125 during prior sessions. In this manner, the models 175 can be trained across a large data set by incorporating data associated with multiple structures 170, entities 180, or nodes 190, although the models 175 can operate for client devices 125 associated with one structure 170, entity 180, or node 190, or less entities 180 than the entire set of entities, or less nodes 190 than the entire set of nodes.

The model trainer 150 trains one or more of the models 175 to generate a scenario 185 including impacts to a performance of the structure 170 of entities 180. In some aspects of the technical solutions described herein, one or more of the models 175 is trained to identify one or more entities within the structure 170 of entities 180 whose performance could be impacted by the criteria received from a client device 125 associated with a first entity of the structure 170 of entities 180 based on one or more historical data sets. Responsive to identifying entities whose performance could be impacted by the criteria, the model trainer 150 trains one or more of the models 175 to request an input from a client device 125 associated with the impacted entity. In some aspects of the technical solutions described herein, the model trainer 150 trains one or more of the models 175 to generate a second scenario by receiving as inputs the criteria, the data set 165, and additional criteria from one or more client devices 125. In some aspects of the technical solutions described herein, the model trainer 150 trains one or more of the models 175 to generate the scenario 185 including a first plurality of scenarios by receiving as inputs the criteria and the data set 165. In some aspects of the technical solutions described herein, the model trainer 150 trains one or more of the models 175 to generate a plurality of second scenarios responsive to the controller 160 presenting the scenario 185 to the first node by receiving as inputs the criteria, the data set 165, and additional criteria from the first node.

The model trainer 150 instructs the resource and parameters module 130, the data parser 140, and the scenario actuator 145 to aggregate the training data set to train, generate, or establish the models 175. The model trainer 150 trains the models 175 using the training data set, a subset of the training data set, historical data, input data by a user of a client device 125. The model trainer 150 segments, subsects divides, or otherwise creates subsets of the training data set to train the models 175. The model trainer 150 can divide the training data set based on a percentage of information. For example, the model trainer 150 divides the training data set into two subsets wherein the first subset can include 30% of the digital information in GB and the second subset includes 70% of the information in GB. The model trainer 150 can divide the training data set based on data type, a time received, or the source of the data, among others.

The model trainer 150 feeds, supplements, or provides the input training data set as inputs to the models 175 to train the models 175. The inputs are or include the inputs as described herein in addition to the input training data set. The model trainer 150 uses the input training data set to train models 175 based on known outputs of the input training data set. The input training data set can be annotated by a user of a client device 125 or otherwise have known outputs or incomes. By providing the input training data set with the inputs and known outputs to the models 175, the model trainer 150 generates the trained models 175. For example, the input training data set includes a large variety of data types, criteria, or parameters, among others. The input training data set can be marked to distinguish each attribute of the input training data set. The model trainer 150 generates the trained models 175 by providing the inputs to create the known outputs. This process can be iterative and can utilize any of the inputs or machine learning models described herein.

The model trainer 150 validates the trained models 175 using a test data set. With generation of the models 175, the model trainer 150 provides inputs based on the test data set to determine a validity of each of the models 175. The validity of each of the models 175 can relate to an error. The error is the difference between the known outcomes of the test data set and actual outcomes when inputs based on the test data set are provided to the models 175. For example, the test data set includes a known input and outcome. Upon providing the known input to a model 175 trained to accept that input, the model 175 provides the known outcome, or can provide a different, erroneous outcome. This comparison between the known outcome and the model-generated outcome can be repeated for various inputs of a model 175 to generate an overall error score or rate. The error score or rate relates to the validity of the model 175. If the error score or rate for the model 175 exceeds a threshold error, the model 175 is considered invalid or erroneous. If the error score or rate for the model 175 is at or below the threshold error, the model 175 is considered valid. In this manner, each model 175 is validated.

The model trainer 150 retrains the models 175. The model trainer 150 can retrain the models 175 responsive to the error score of one of the models 175 being above a threshold error. In some cases, the model trainer 150 determines the error score of the models 175 is above the threshold error (e.g., invalid) responsive to generation of the models 175 by the model trainer 150. For example, the model trainer 150 determines that a model 175 of the models is invalid based on an error score of the model 175 exceeding an error threshold for the model 175 upon generation. The model trainer 150 determines that the models 175 are invalid prior to storing the models 175 in the data repository 115. The model trainer 150 can check the models 175 periodically to determine validity of the models 175. For example, model 175 which was once valid can drift, or become less valid or have a higher error score over time. The model trainer 150 checks the validity of the models 175 stored in the data repository 115, the models 175 generated by the model trainer 150, or the models of the system 100.

Upon the model trainer 150 determining that one or more models 175 are invalid, (e.g., the error score is above the threshold error), the model trainer 150 instructs the resource and parameters module 130, the data parser 140, or the scenario actuator 145 to aggregate, collect, or retrieve a second training data set. With receipt of the second training data set, the model trainer 150 retrains the models 175. The model trainer 150 divides the second training data set into subsets, such as a second training input data and a second test data. The model trainer 150 combines the training data set and the second training data set. For example, the model trainer 150 incorporates, combines, or adds the second training data to the training data. With the aggregation of the second training data set, the model trainer 150 provides further inputs and known outcomes to further train the models 175. The model trainer 150 retrains the models 175 with an error score above the threshold error, all of the models 175, or selected models 175. The model trainer 150 can retrain the models 175 or a subset of the models 175 subsequent to the elapse of a period of time. For example, the model trainer 150 retrains a model 175 every week, every year, upon its error score exceeding the threshold error for the model 175, or never retrains the model 175.

The model trainer 150 checks the retrained models 175 for validity. The model trainer 150 checks or tests the retrained models 175 as described herein, by comparing an error score of each model 175 with a threshold error for each model 175. Upon the model trainer 150 determining that one or more of the retrained models 175 are invalid, the model trainer 150 aggregates a third training data set and repeats the retraining process. The retraining process can be repeated until the error score of the model 175 is below the threshold error. The model trainer 150 can issue an alert or notification if the model 175 fails testing or retraining a threshold number of times.

Upon the model trainer 150 determining that the retrained models 175 or the trained models 175 are valid, the model trainer 150 stores the models 175 in the data repository 115. In some cases, the model trainer 150 replaces a first model with a retrained model 175. The model trainer 150 replaces the first model with the retrained model 175 based on user input, or based on the first model having an error score above the threshold. In this manner, models 175 which have drifted, become erroneous, or no longer represent the data set 165 are replaced by the model trainer 150 to ensure the validity of the system 100.

The model trainer 150 generates or validates the models 175 in parallel, series, or combination thereof. For example, the model trainer 150 generates, validates, or stores a first model prior to the generation of a second model. In some aspects of the technical solutions described herein, a subsequent model uses as input an outcome of a prior model. In these aspects of the technical solutions described herein, the model trainer 150 generates, validates, or stores the subsequent model after the prior model.

The data processing system 105 includes a controller 160 designed, constructed, and operational to determine whether the one or more impacts of the scenarios 185 are above a threshold for a first node of the nodes 190, present the scenario 185 including the one or more impacts to the first node via client devices 125 associated with the first node, and execute an action 155 associated with the scenario 185 for the structure 170 of entities 180. The controller 160 can determine the first node according to the criteria received from the client device 125. The controller 160 can determine a second node according to additional criteria received from the client device 125 or a second client device. The controller 160 can determine the first node according to historical data or previous models 175 generated by the scenario actuator 145. The controller 160 can determine the first node by analyzing the structure 170 of entities 180.

The threshold can be a metric used to measure the impact the scenario 185 has on the structure 170 of entities 180. The threshold can be a fiscal amount of money or a percentage, among others. The threshold can be determined by the controller 160, or can be set by user input via a client device 125 associated with at least one of the nodes 190. The threshold can be used to measure negative impacts on the structure 170 of entities 180 (e.g., a scenario 185 with an impact exceeding threshold indicates the performance of the structure 170 of entities 180 will be adversely impacted by the criteria), or positive impacts on the structure 170 of entities 180 (e.g., a scenario 185 with an impact exceeding the threshold indicates the performance of the structure 170 of entities 180 will be positively impacted). By analyzing the criteria, the model 175, or the scenario 185, the controller 160 can override or modify the threshold. The controller 160 can receive input from a client device 125 associated with a node 190 of the structure 170 of entities 180 overriding or modifying the threshold.

The controller 160 presents the scenario 185 including the one or more impacts to the first node via client devices 125 associated with the first node. The presentation can be through a graphical user interface or an application. The application can be hosted by the client devices 125 associated with the first node, or by the network 101.

The controller 160 executes an action 155 associated with the scenario 185 for the structure 170 of entities 180. The controller 160 can execute the action 155 automatically without any input from a client device 125. The controller 160 can execute a second action associated with a second scenario for the structure 170 of entities 180 to control an impact on the first node. The controller 160 can require input from at least one client device 125 associated with the first node. The controller 160 can assign an input requirement to a client device 125 associated with a second node of the structure 170 of entities 180. The controller 160 can present a confirmation of the action 155 to a first entity. The presentation can be via a client device 125 associated with the first entity. The controller 160 can execute the action 155 responsive to receiving an indication confirming execution of the action 155 from the first entity. The controller 160 can present a confirmation of the action to a second entity via a client device 125 associated with the second entity. The controller 160 can execute the action 155 responsive to receiving an indication confirming execution of the action 155 from the second entity, or responsive to receiving an indication confirming execution of the action 155 from the first entity and the second entity. The controller 160 can determine that a confirmation of the action 155 is not necessary and execute the action 155 responsive to this determination.

The actions 155 are one or more an activities or processes associated with the scenario 185 generated by the scenario actuator 145. The actions 155 are stored in the data repository 115. The controller 160 can select the action 155 from a predetermined list of actions associated with the one or more impacts (e.g., associated with the scenarios 185). The controller 160 can select the action 155 from a list of predetermined actions associated with the model 175. The action 155 can be received as user input from a client device 125. In an illustrative example, the action 155 can be a creation of a new entity within the structure 170 of entities 180. In an illustrative example, the action 155 can be a removal of an existing entity within the structure 170 of entities 180. In an illustrative example, the action 155 can be a user input requirement from a client device 125 associated with an entity 180 within the structure 170 of entities 180. In an illustrative example, the action 155 can be a creation of a new model 175 by the scenario actuator 145. In an illustrative example, the action 155 can be a creation or removal of a position within the structure 170 of entities 180. In an illustrative example, the action 155 can be a budget increase or decrease for the structure 170 of entities 180, or of one or more entities within the structure 170 of entities 180. In an illustrative example, the action 155 can be the initiation of an approval process specific to an entity within the structure 170 of entities 180.

The database 110 is or includes a system or computing device including the data 165. The database 110 is or includes a storage or data repository to store the data 165. The database 110 is located remotely from the data processing system 105 or the client device 125. In some aspects of the technical solutions described herein, the database 110 is maintained, owned, or operated by the same entity as the entity maintaining, owning, or operating the data processing system 105. Alternatively or in addition, the database 110 is maintained by an outside entity such as a government, individual, company, or non-profit organization. Although a single database 110 is depicted, the database 110 can include multiple databases.

The database 110 maintains, includes, stores, or otherwise hosts the data 165. The data 165 are any set of aggregated, accumulated, calculated, generated, or otherwise available to an entity. The data 165 include information about an entity. The entity includes an individual, such as an employee of an organization as described herein, or a grouping of people, such as an organization, corporation, or educational institution. The information includes data like name, address, social security number, salary, personally identifying information, demographic information, familial information, tax information, benefits information, or other such information. The data 165 include information about an entity such as a location of the entity (e.g., an address, physical or coordinate location, a geofence associated with the entity), employees of the entity, tax information, financial information, proprietary information, among other information. For example, the database 110 can be an external computing system maintaining a data repository of the average salary the average salary for employees of a specific entity. In this example, the collection of salaries can be included in the data 165.

In an illustrative example, the resource and parameters module 130 receives a data set 165 associated with resource utilization of a structure 170 of entities 180. The structure 170 of entities 180 includes nodes 190 that define related entities of the structure 170 of entities 180 using one or more parameters correlated to the data set 165. The data parser 140 receives criteria defining a change in the data set 165 from a client device 125 associated with a first entity of the structure 170 of entities 180. The scenario actuator 145 generates a scenario 185 including impacts to a performance of the structure 170 of entities 180 by providing the criteria and the data set 165 as inputs to a machine learning model 175. The controller 160 determines the one or more impacts are above a threshold impact for a first node of the nodes 190. The controller 160 presents the scenario 185 including the one or more impacts to the first node via client devices 125 associated with the first node. The controller 160 executes an action 155 associated with the scenario 185 for the structure 170 of entities 180.

In an illustrative example, the data parser 140 receives from the first node, responsive to the controller 160 presenting the scenario 185 to the first node, additional criteria from the client devices 125 associated with the first node. The scenario actuator 145 generates a second scenario by providing the criteria, the data set 165, and the additional criteria as inputs to the machine learning model 175. The controller 160 executes a second action associated with the second scenario for the structure 170 of entities 180.

In an illustrative example, the scenario actuator 145 generates the scenario 185 including a first plurality of scenarios by providing the criteria and the data set 165 as inputs to the machine learning model 175. The controller 160 determines that one or impacts are above the threshold impact for the first node for each scenario 185 of the first plurality of scenarios. The controller 160 presents each scenario of the first plurality of scenarios that are above the threshold impact to the first node via the client devices 125 associated with the first node.

In an illustrative example, the scenario actuator 145 generates a plurality of second scenarios, responsive to the controller 160 presenting the scenario to the first node, by providing the criteria, the data set 165, and additional criteria from the first node as inputs to the machine learning model 175. The controller 160 receives from the first entity a selection of the scenario 185 from the plurality of second scenarios.

In an illustrative example, the scenario actuator 145 generates a plurality of scenarios including the one or more impacts for each scenario 185 of the plurality of scenarios by providing the criteria and the data set 165 as inputs to the machine learning model 175. The controller 160 determines a corresponding node of nodes for each scenario 185 of the plurality of scenarios with the one or more impacts above a threshold impact. The controller 160 presents each scenario 185 of the plurality of scenarios to its corresponding node via client devices 125 associated with each corresponding node. The controller 160 receives, from the client devices 125 associated with each corresponding node, a selection of the scenario 185 from the plurality of scenarios. The controller 160 executes an action 155 associated with the scenario 185 for the structure 170 of entities 180 based on the selected scenario.

In an illustrative example, the data parser 140 identifies a subset of the data set based on the criteria. The scenario actuator 145 provides the subset of the data as input to the machine learning model 175 to determine the one or more impacts (e.g., the scenario 185).

In an illustrative example, the controller 160 presents a confirmation of the action 155 to the first entity. The controller 160 executes the action 155 responsive to receiving an indication confirming execution of the action 155 from the first entity.

In an illustrative example, the structure 170 of entities 180 comprises entities 180 related to one or more of: time entry, payroll, human resources, compensation, benefits, real estate, or finance.

In an illustrative example, the controller 160 selects the action 155 from a list of predetermined actions associated with the one or more impacts (e.g., the scenario 185).

In an illustrative example, the criteria includes a first change to one or more parameters of the data set 165.

In an illustrative example, the first node includes the first entity.

In an illustrative example, the data parser 140 receiving the criteria defining the change in the data set 165 from the client device 125 associated with the first entity of the structure 170 of entities 180 includes: the scenario actuator 145 determining a suggestion of the criteria using historical data associated with the first entity as input to a second machine learning model using natural language learning, the controller 160 presenting, via the client device associated with the first entity, the suggestion of the criteria, and the controller 160 receiving a selection of the criteria from the suggestion of the criteria. The selection of the criteria can be received from a client device 125 associated with the first node.

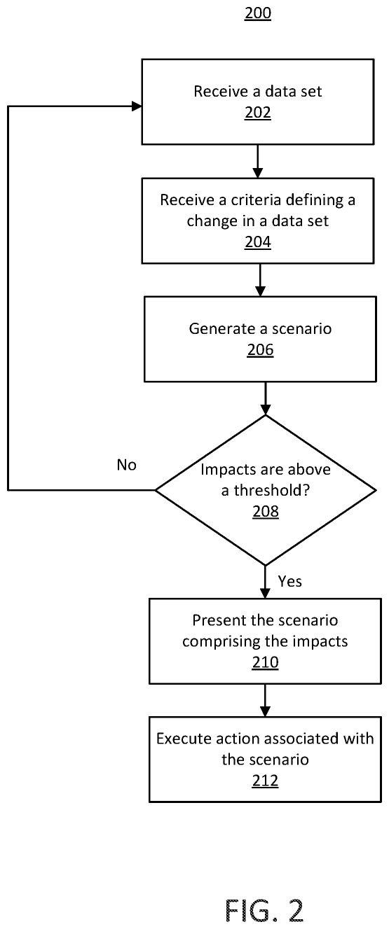

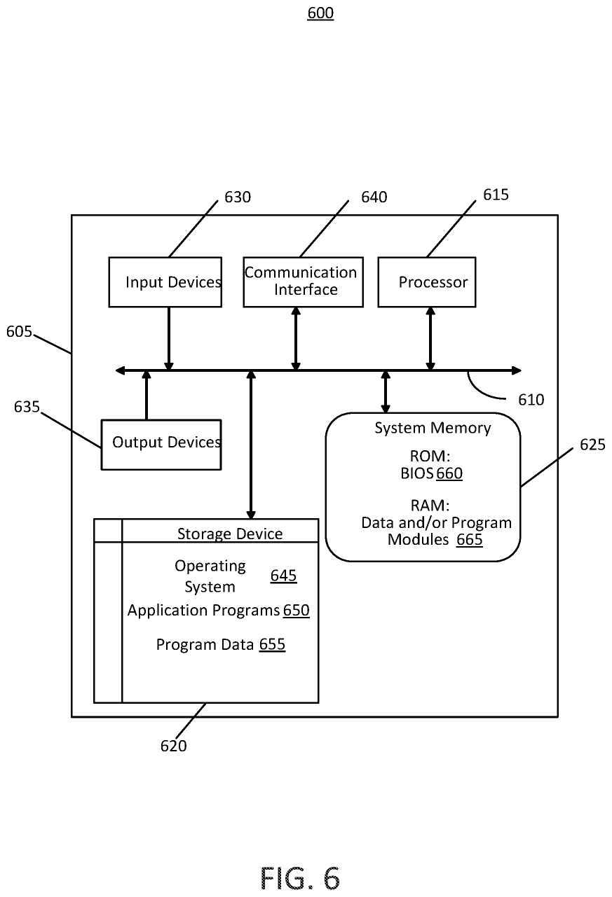

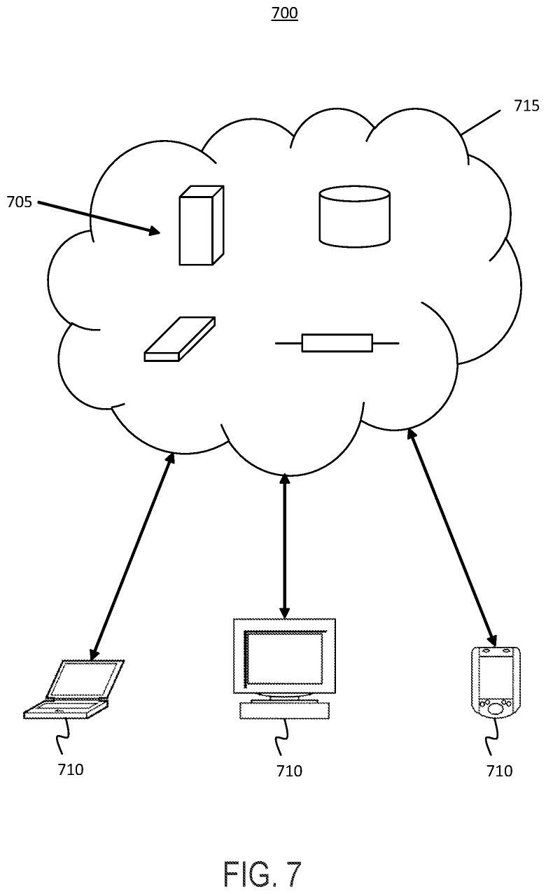

FIG. 2 depicts an example method 200 for predicting impacts on a performance of a structure of entities. The method 200 can be performed by one or more systems or components depicted in FIG. 1, FIG. 6, or FIG. 7, including, for example, a data processing system. At ACT 202, the method 200 can include the data processing system receiving a data set. The data set includes resource utilization of a structure of entities. The structure of entities includes nodes. The nodes define related entities of the structure of entities using one or more parameters correlated to the data set. The data processing system can receive the data set from one or more sources, such as from a client device associated with the structure of entities. The data processing system can receive the data set at any time and in any format or type of data set. The data processing system can receive the data set over a network, a hard-wired connection, or from operator output. The data set can be sent as an electronic file. The data set can include or be subdivided into sheets. The data set can include values, where each value is a portion of the data set. Each sheet of the data set can include one or more values. The data processing system can determine the parameters of the data set by determining what types of information are contained in the data set

The data processing system can receive the data set in real-time, via a data stream, periodically (e.g., every 1 second, 2 seconds, 3 seconds, 5 seconds, 10 seconds, 15 seconds, 20 seconds, 30 seconds, 60 seconds, or other time interval). The data processing system can request the data set from the sources, such as via a poll, query, ping, or fetch operation. The data processing system can request the data set responsive to a condition or event, such as detecting a new source connected to the network, a change in a structure of entities, or a change in the electronic transaction system.

The data processing system can detect, determine, or identify a data type of the data set. A data type can include a pre-defined label corresponding to a value of the data set. For example, a data type can be master data, indicative data, balance data, tax data, employee data, node data, entity data, resource utilization data, resource availability data, among others. Each data type can have one or more labels corresponding to it. For example, employee data type can include the labels “EMPLOYEE DATA” or the labels “DATE OF BIRTH,” “GENDER,” “HOME ADDRESS.” Each label can be subdivided and can include more or other labels. For example, the label “EMPLOYEE DATA” can include the labels “SALARY” and “PEOPLE HOURS.” The data processing system can determine the parameters of the data set according to one or more labels of the data type.

At ACT 204, the data processing system receives a criteria defining a change in the data system. The criteria is received from a client device associated with a first entity of the structure of entities. The criteria can be a change in one or more parameters. The criteria can be associated with a change in resource utilization for the structure of entities. The criteria can be a change of an entity.

At ACT 206, the data processing system generates a scenario including impacts to a performance of the structure of entities by providing the criteria and the data set as inputs to a machine learning model. The scenario is or includes the scenarios 185 of FIG. 1. In some instances, the data processing system uses the scenario to identify one or more nodes of the structure of entities whose performance is impacted by the scenario. In some instances, the data processing system provides the identified one or more nodes as an additional input to the machine learning model. The data processing system identifies one or more nodes or entities within the structure of entities whose performance is be impacted by the criteria. The data processing system can generate a plurality of scenarios (e.g., the scenario can be a first plurality of scenarios).

At decision block 208, the data processing system determines if the one or more impacts of the scenario are above a threshold impact. The threshold impact can be a measurement of negative performance for one or more entities or nodes within the structure of entities (e.g., the scenario generated using the criteria will cause a negative impact to the structure of entities). The threshold impact can be a measurement of positive performance for one or more entities or nodes within the structure of entities (e.g., the scenario generated using the criteria will cause a positive impact to the structure of entities). The threshold can be determined automatically by the data processing system. The data processing system can determine the threshold according to user input from a client device associated with the structure of entities. The data processing system can determine the threshold according to the criteria received from the client device associated with the first entity of the structure of entities. The data processing system can determine the threshold according to the model used to create the scenario. Where the scenario is a first plurality of scenarios, the data processing system can determine that the one or more impacts are above the threshold impact for the first node for each scenario of the first plurality of scenarios.

Upon a determination that the one or more impacts of the scenario are above the threshold, the data processing system presents the scenario including the one or more impacts to the first node via client devices associated with the first node (ACT 210). The data processing system determines which client devices associated with the first node to present the scenario including the one or more impacts to. The data processing system can present the scenario including the one or more impacts to client devices associated with a second node. The data processing system can present the scenario including the one or more impacts to client devices associated with an entity of the structure of entities. The data processing system can determine to present the scenario including the one or more impacts to client devices associated with one or more nodes or one or more entities associated with the structure of entities according to one or more of: the criteria, the model used to generate the scenario, the scenario, the data set, parameters of the data set, a subset of the data set, historical data, or user input from a client device associated with the structure of entities.

Responsive to presenting the scenario to the first node, the data processing system can generate a plurality of second scenarios by providing the criteria, the data set, and additional criteria from the first node as inputs to the machine learning model. The additional criteria can be changes to the parameters of the data set. The additional criteria can be additional parameters to the data set. The data processing system can receive a selection from the first entity of the scenario from the plurality of second scenarios.

At ACT 212, the data processing system executes an action associated with the scenario for the structure of entities responsive to the one or more impacts being above the threshold impact. The data processing system can select the action from a predetermined list of actions. The data processing system can receive the action from a client device associated with an entity of the structure of entities. The data processing system can present a confirmation of the action to the first entity. The data processing system can execute the action associated with the scenario for the structure of entities based on the selected scenario.

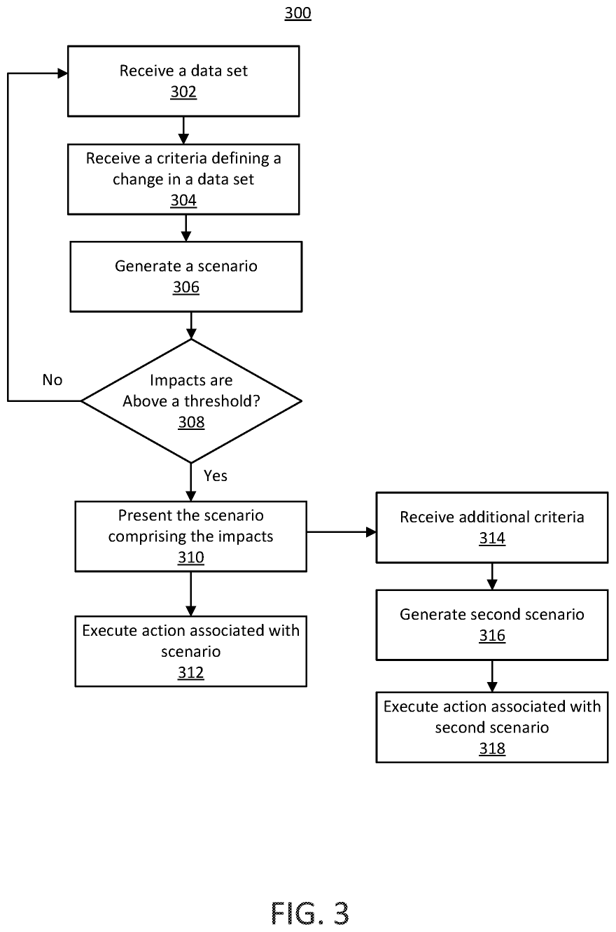

FIG. 3 depicts an example method 300 for predicting impacts on a performance of a structure of entities. The method 300 can be performed by one or more systems or components depicted in FIG. 1, FIG. 6, or FIG. 7, including, for example, a data processing system. At ACT 302, the method 300 can include the data processing system receiving a data set. The data set is associated with resource utilization of a structure of entities including nodes. The nodes define related entities of the structure of entities using one or more parameters correlated to the data set. The data processing system can receive the data set from one or more sources. The data processing system can receive the data set at any time and in any format or type of data set. The data processing system can receive the data set over a network, a hard-wired connection, or from operator output. The data set can be sent as an electronic file. The data set can include or be subdivided into sheets. The data set can include values, where each value is a portion of the data set. Each sheet of the data set can include one or more values. The data processing system can determine the parameters of the data set by determining what types of information are contained in the data set

The data processing system can receive the data set in real-time, via a data stream, periodically (e.g., every 1 second, 2 seconds, 3 seconds, 5 seconds, 10 seconds, 15 seconds, 20 seconds, 30 seconds, 60 seconds, or other time interval). The data processing system can request the data set from the sources, such as via a poll, query, ping, or fetch operation. The data processing system can request the data set responsive to a condition or event, such as detecting a new source connected to the network, a change in a structure of entities, or a change in the electronic transaction system.

The data processing system can detect, determine, or identify a data type of the data set. A data type can include a pre-defined label corresponding to a value of the data set. For example, a data type can be master data, indicative data, balance data, tax data, employee data, node data, entity data, resource utilization data, resource availability data, among others. Each data type can have one or more labels corresponding to it. For example, employee data type can include the labels “EMPLOYEE DATA” or the labels “DATE OF BIRTH,” “GENDER,” “HOME ADDRESS.” Each label can be subdivided and can include more or other labels. For example, the label “EMPLOYEE DATA” can include the labels “SALARY” and “PEOPLE HOURS.” The data processing system can determine the parameters of the data set according to one or more labels of the data type.

At ACT 304, the data processing system receives a criteria defining a change in the data system. The criteria is received from a client device associated with a first entity of the structure of entities. The criteria can be a change in one or more parameters. The criteria can be associated with a change in resource utilization for the structure of entities. The criteria can be a change of an entity.

At ACT 306, the data processing system generates a scenario including impacts to a performance of the structure of entities by providing the criteria and the data set as inputs to a machine learning model. The scenario is or includes the scenarios 185 of FIG. 1. In some instances, the data processing system uses the scenario to identify one or more nodes of the structure of entities whose performance will be impacted by the scenario. In some instances, the data processing system provides the identified one or more nodes as an additional input to the machine learning model. The data processing system identifies one or more nodes or entities within the structure of entities whose performance will be impacted by the criteria.

At decision block 308, the data processing system determines if the one or more impacts of the scenario are above a threshold impact. The threshold impact can be a measurement of negative performance for one or more entities or nodes within the structure of entities (e.g., the scenario generated using the criteria will cause a negative impact to the structure of entities). The threshold impact can be a measurement of positive performance for one or more entities or nodes within the structure of entities (e.g., the scenario generated using the criteria will cause a positive impact to the structure of entities). The threshold can be determined automatically by the data processing system. The data processing system can determine the threshold according to user input from a client device associated with the structure of entities. The data processing system can determine the threshold according to the criteria received from the client device associated with the first entity of the structure of entities. The data processing system can determine the threshold according to the model used to create the scenario.

Upon a determination that the one or more impacts of the scenario are above the threshold, the data processing system presents the scenario including the one or more impacts to the first node via client devices associated with the first node (ACT 310). The data processing system determines which client devices associated with the first node to present the scenario including the one or more impacts to. The data processing system can present the scenario including the one or more impacts to client devices associated with a second node. The data processing system can present the scenario including the one or more impacts to client devices associated with an entity of the structure of entities. The data processing system can determine to present the scenario including the one or more impacts to client devices associated with one or more nodes or one or more entities associated with the structure of entities according to one or more of: the criteria, the model used to generate the scenario, the scenario, the data set, parameters of the data set, a subset of the data set, historical data, or user input from a client device associated with the structure of entities.

At ACT 312, the data processing system executes an action associated with the scenario for the structure of entities. The data processing system can select the action from a predetermined list of actions. The data processing system can receive the action from a client device associated with an entity of the structure of entities. The action can be executed responsive to the one or more impacts being above the threshold impact.

At ACT 314, the data processing system receives, responsive to presenting the scenario to the first node, additional criteria from the client devices associated with the first node. The additional criteria can be feedback from client devices associated with the first node. The criteria can be a change in one or more parameters of the data set. The criteria can be a change in resource utilization for the structure of entities.

At ACT 316, the data processing system generates a second scenario by providing the criteria, the data set, and the additional criteria as inputs to the machine learning model. The second scenario is or includes the scenarios 185 of FIG. 1. The data processing system can present the second scenario to client devices associated with the first node or to client devices associated with a second node of the structure of entities. The data processing system can present the second scenario in addition to or instead of the first scenario. The data processing system can receive a selection of the scenario or the second scenario from a client device associated with an entity of the structure of entities.

At ACT 318, the data processing system executes a second action associated with the second scenario for the structure of entities. The data processing system can execute the second action in addition to or instead of the action. The data processing system can determine not to execute the action until additional criteria are received from client devices associated with the first node. The data processing system can determine that the one or more impacts of the second scenario are above a second threshold impact. The system can determine, according to the additional criteria from client devices associated with the first node, not to make a threshold impact determination for impacts of the second scenario.

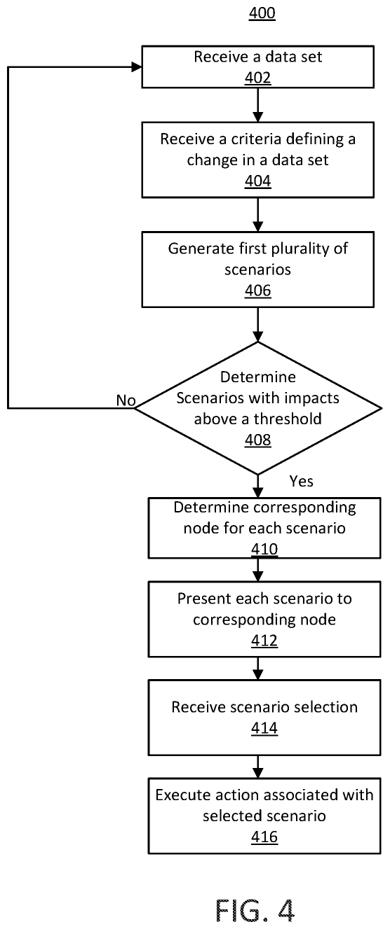

FIG. 4 depicts an example method 400 for predicting impacts on a performance of a structure of entities. The method 400 can be performed by one or more systems or components depicted in FIG. 1, FIG. 6, or FIG. 7, including, for example, a data processing system. At ACT 402, the method 400 can include the data processing system receiving a data set. The data set is associated with resource utilization of a structure of entities including nodes. The nodes define related entities of the structure of entities using one or more parameters correlated to the data set. The data processing system can receive the data set from one or more sources. The data processing system can receive the data set at any time and in any format or type of data set. The data processing system can receive the data set over a network, a hard-wired connection, or from operator output. The data set can be sent as an electronic file. The data set can include or be subdivided into sheets. The data set can include values, where each value is a portion of the data set. Each sheet of the data set can include one or more values. The data processing system can determine the parameters of the data set by determining what types of information are contained in the data set.

The data processing system can receive the data set in real-time, via a data stream, periodically (e.g., every 1 second, 2 seconds, 3 seconds, 5 seconds, 10 seconds, 15 seconds, 20 seconds, 30 seconds, 60 seconds, or other time interval). The data processing system can request the data set from the sources, such as via a poll, query, ping, or fetch operation. The data processing system can request the data set responsive to a condition or event, such as detecting a new source connected to the network, a change in a structure of entities, or a change in the electronic transaction system.

The data processing system can detect, determine, or identify a data type of the data set. A data type can include a pre-defined label corresponding to a value of the data set. For example, a data type can be master data, indicative data, balance data, tax data, employee data, node data, entity data, resource utilization data, resource availability data, among others. Each data type can have one or more labels corresponding to it. For example, employee data type can include the labels “EMPLOYEE DATA” or the labels “DATE OF BIRTH,” “GENDER,” “HOME ADDRESS.” Each label can be subdivided and can include more or other labels. For example, the label “EMPLOYEE DATA” can include the labels “SALARY” and “PEOPLE HOURS.” The data processing system can determine the parameters of the data set according to one or more labels of the data type.

At ACT 404, the data processing system receives a criteria defining a change in the data system. The criteria is received from a client device associated with a first entity of the structure of entities. The criteria can be a change in one or more parameters. The criteria can be associated with a change in resource utilization for the structure of entities. The criteria can be a change of an entity.

At ACT 406, the data processing system generates a plurality of scenarios including impacts for each scenario to a performance of the structure of entities by providing the criteria and the data set as inputs to a machine learning model. The plurality of scenarios is or includes the scenarios 185 of FIG. 1. The data processing system can generate the plurality of scenarios using a plurality of models. The data processing system can generate the plurality of scenarios using a plurality of inputs from one or more client devices associated with the structure of entities. The plurality of scenarios can indicate different ways a performance of the structure of entities can be impacted by a change in resource utilization. For example, one scenario of the plurality of scenarios can identify impacts to a performance of a structure of entities if the structure of entities were to hire 10 new employees into a currently existing entity, while another scenario of the plurality of scenarios can identify impacts to the performance of the structure of entities if a new entity in a new geographic location was created to hire the 10 new employees.

At decision block 408, the data processing system determines whether the one or more impacts of each scenario of the plurality of scenarios are above a threshold impact. The threshold impact can be a measurement of negative performance for one or more entities or nodes within the structure of entities (e.g., the scenario generated using the criteria will cause a negative impact to the structure of entities). The threshold impact can be a measurement of positive performance for one or more entities or nodes within the structure of entities (e.g., the scenario generated using the criteria will cause a positive impact to the structure of entities). The threshold can be determined automatically by the data processing system. The data processing system can determine the threshold according to user input from a client device associated with the structure of entities. The data processing system can determine the threshold according to the criteria received from the client device associated with the first entity of the structure of entities. The data processing system can determine the threshold according to the model used to create the plurality of scenarios.

At ACT 410, the data processing system determines a corresponding node of the nodes for each scenario of the plurality of scenarios with impacts above the threshold impact. The data processing system can determine the corresponding node according to an entity impacted by the scenario. The data processing system can determine the corresponding node by analyzing the structure of entities. The data processing system can determine the corresponding node by receiving user input from a client device associated with the structure of entities. The data processing system can determine the corresponding node according to historical data. The data processing system can determine the corresponding node by providing the scenario as an input to a second machine learning model.

At ACT 412, the data processing system presents each scenario of the plurality of scenarios to its corresponding node via client devices associated with the node. The data processing system determines which client devices associated with the corresponding node to present each scenario to. The data processing system can present the scenarios through a graphical user interface or an application, among others.

At ACT 414, the data processing system receives, from the client devices associated with each corresponding node, a selection of the scenario from the plurality of scenarios. At ACT 416, the data processing system executes an action associated with the scenario for the structure of entities associated with the selected scenario. The action can be executed responsive to the one or more impacts being above the threshold impact.

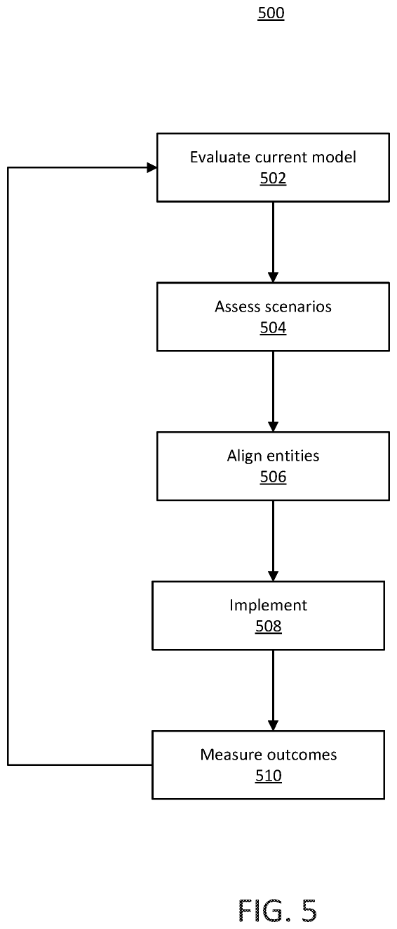

FIG. 5 depicts an example method 500 for predicting global impacts on a performance of a structure of entities. The method 500 can be performed by one or more systems or components depicted in FIG. 1, FIG. 6, or FIG. 7, including, for example, a data processing system. At ACT 502, the data processing system evaluates the current model being used by the data processing system. This evaluation process can happen in real time or it can be periodic (e.g., once every millisecond, second, minute, hour, day month, year or some other measurement of time). The current model can be one of the models 175. The data processing system can measure resource utilization for a structure of entities. Resource utilization can be defined as one or more resources necessary for a structure of entities to function. Resources can include number of total employees, office space, office materials, number of entities within the structure of entities, manufacturing materials, IT support, people hours, among others. Evaluating the current model can mean identifying the current model. The data processing system receives, from a client device associated with the structure of entities, a data set including resource utilization for the structure of entities. The data processing system determines one or more parameters associated with the data set.

At ACT 504, the data processing system assesses scenarios for the structure of entities. The scenarios can be one or more proposed changes in resource utilization for the structure of entities. For example, a scenario can be creating a new entity within the structure of entities (e.g., a new division of the company), hiring more employees, firing employees, changing health benefits offered to employees, increasing or decreasing a production output, increasing or changing a sales price, changing the structure of entities' bonus structure, entering a new geographical market, changing a return policy, among others. The proposed change in resource utilization can be received as a criteria from a client device associated with the structure of entities. The data processing system assesses the scenarios by determining what impacts the proposed change in resource utilization will have on a performance of the structure of entities. The data processing system can implement one or more models 175 to make this assessment. The data processing system determines which entities among the structure of entities could have a performance impacted by the proposed change in resource utilization. The data processing system determines which nodes could have a performance impacted by the proposed change in resource utilization, the nodes to define related entities of the structure of entities.

At ACT 506, the data processing system aligns entities within the structure of entities according to the assessment of scenarios. Aligning entities can include receiving input from entities determined at ACT 504. Aligning entities can include notifying entities determined in ACT 504 of an impact to a performance of the entity. Aligning entities can include creating a collaborative model among entities within the structure of entities by assigning different tasks associated with the proposed change in resource utilization. Aligning entities can include providing information to all entities within the structure of entities regarding the one or more impacts of the proposed change in resource utilization. Aligning entities involves coming to a final decision regarding the proposed change in resource utilization.

At ACT 508, the data processing system implements the decision agreed upon in ACT 506. The data processing system can implement the decision automatically. The data processing system can require an approval from one or more entities within the structure of entities regarding the decision. The data processing system can execute one or more actions associated with the decision. For example, where the proposed change in resource utilization was to create a new entity within the structure of entities, and the decision approved the creation of this entity, the data processing system could undertake actions associated with that decision, such as allocating funds for employees or materials for the new entity, implementing the creation of the new entity into a model being used by the data processing system, or presenting actions for approval to one or more entities within the structure of entities.

At ACT 510, the data processing system measures the outcomes of the decision implemented in ACT 508. The data processing system receives data from the structure of entities and measures a performance of the structure of entities to determine the accuracy of the model used to implement the change in resource utilization. The data processing system measures the outcomes of the decision while evaluating the current model in use, as in ACT 502.

FIG. 6 is an illustrative architecture of a computing system 600 implemented in embodiments of the technical solutions described herein. The computing system 600 is only one example of a suitable computing system and is not intended to suggest any limitation as to the scope of use or functionality of the technical solutions described herein. Also, computing system 600 should not be interpreted as having any dependency or requirement relating to any one or combination of components illustrated in computing system 600.

As shown in FIG. 6, computing system 600 includes a computing device 605. The computing device 605 can be resident on a network infrastructure such as within a cloud environment as shown in FIG. 7, or can be a separate independent computing device (e.g., a computing device of a third party service provider). The computing device 605 can include a bus 610, a processor 615, a storage device 620, a system memory (hardware device) 625, one or more input devices 630, one or more output devices 635, and a communication interface 640.

The bus 610 permits communication among the components of computing device 605. For example, bus 610 can be any of several types of bus structures including a memory bus or memory controller, a peripheral bus, and a local bus using any of a variety of bus architectures to provide one or more wired or wireless communication links or paths for transferring data and/or power to, from, or between various other components of computing device 605.

The processor 615 can be one or more processors or microprocessors that include any processing circuitry operative to interpret and execute computer readable program instructions, such as program instructions for controlling the operation and performance of one or more of the various other components of computing device 605. In embodiments, processor 615 interprets and executes the processes, steps, functions, and/or operations of the technical solutions described herein, which can be operatively implemented by the computer readable program instructions.

For example, processor 615 provides an enterprise-wide security approach with all stakeholders (e.g., Dev teams, leadership, CSO office, etc.) with a set of various security scanner types and information sources integrated into a single tool. In embodiments, the processor 615 uniformly integrates or packages existing scanner types into a single tool that standardizes and visually displays the output over different development teams for different scanner types. The scanner types which are packaged into the integrated security tool can capture specific requirements of the different teams, i.e., ensures that the tools support varied team development methodologies and different tech stacks to capture required security vulnerabilities. The processor 615 also establishes a regular feedback mechanism, and can be used to develop a process for remediation timelines and priority including at risk vulnerabilities.

In embodiments, processor 615 can receive input signals from one or more input devices 630 and/or drive output signals through one or more output devices 635. The input devices 630 can be, for example, a keyboard, touch sensitive user interface (UI), etc., as is known to those of skill in the art such that no further description is required for a complete understanding of the technical solutions described herein. The output devices 635 can be, for example, any display device, printer, etc., as is known to those of skill in the art such that no further description is required for a complete understanding of the technical solutions described herein.

The storage device 620 can include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 605 in accordance with the different aspects of the technical solutions described herein. In embodiments, storage device 620 can store operating system 645, application programs 650, and program data 655 in accordance with aspects of the technical solutions described herein.

The system memory 625 can include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 660 (BIOS) including the basic routines that help to transfer information between the various other components of computing device 605, such as during start-up, can be stored in the ROM. Additionally, data and/or program modules 665, such as at least a portion of operating system 645, application programs 650, and/or program data 655, that are accessible to and/or presently being operated on by processor 615 can be contained in the RAM.

The communication interface 640 can include any transceiver-like mechanism (e.g., a network interface, a network adapter, a modem, or combinations thereof) that enables computing device 605 to communicate with remote devices or systems, such as a mobile device or other computing devices such as, for example, a server in a networked environment, e.g., cloud environment. For example, computing device 605 can be connected to remote devices or systems via one or more local area networks (LAN) and/or one or more wide area networks (WAN) using communication interface 640.

As discussed herein, computing system 600 can be configured to integrate different scanner types into a single workbench or tool. This allows developers and other team members a uniform approach to assessing security vulnerabilities in a code throughout the enterprise. In particular, computing device 605 can perform tasks (e.g., process, steps, methods and/or functionality) in response to processor 615 executing program instructions contained in a computer readable medium, such as system memory 625. The program instructions can be read into system memory 625 from another computer readable medium, such as data storage device 620, or from another device via the communication interface 640 or server within or outside of a cloud environment. In embodiments, an operator can interact with computing device 605 via the one or more input devices 630 and/or the one or more output devices 635 to facilitate performance of the tasks and/or realize the end results of such tasks in accordance with aspects of the technical solutions described herein. In additional or alternative embodiments, hardwired circuitry can be used in place of or in combination with the program instructions to implement the tasks, e.g., steps, methods and/or functionality, consistent with the different aspects of the technical solutions described herein. Thus, the steps, methods and/or functionality described herein can be implemented in any combination of hardware circuitry and software.

FIG. 7 shows an exemplary cloud computing environment 700 in accordance with aspects of the technical solutions described herein. In embodiments, one or more aspects, functions and/or processes described herein can be performed and/or provided via cloud computing environment 700. As depicted in FIG. 7, cloud computing environment 700 includes cloud resources 705 that are made available to client devices 710 via a network 715, such as the Internet. Cloud resources 705 can be on a single network or a distributed network. Cloud resources 705 can be distributed across multiple cloud computing systems and/or individual network enabled computing devices. Cloud resources 705 can include a variety of hardware and/or software computing resources, such as servers, databases, storage, networks, applications, and platforms that perform the functions provided herein including storing code, running scanner types and provided an integration of plural scanner types into a uniform and standardized application, e.g., display.

Client devices 710 can comprise any suitable type of network-enabled computing device, such as servers, desktop computers, laptop computers, handheld computers (e.g., smartphones, tablet computers), set top boxes, and network-enabled hard drives. Cloud resources 705 are typically provided and maintained by a service provider so that a client does not need to maintain resources on a local client device 710. In embodiments, cloud resources 705 can include one or more computing system 600 of FIG. 6 that is specifically adapted to perform one or more of the functions and/or processes described herein.

Cloud computing environment 700 can be configured such that cloud resources 705 provide computing resources to client devices 710 through a variety of service models, such as Software as a Service (SaaS), Platforms as a service (PaaS), Infrastructure as a Service (IaaS), and/or any other cloud service models. Cloud resources 705 can be configured, in some cases, to provide multiple service models to a client device 710. For example, cloud resources 705 can provide both SaaS and IaaS to a client device 710. Cloud resources 705 can be configured, in some cases, to provide different service models to different client devices 710. For example, cloud resources 705 can provide SaaS to a first client device 710 and PaaS to a second client device 710.

Cloud computing environment 700 can be configured such that cloud resources 705 provide computing resources to client devices 710 through a variety of deployment models, such as public, private, community, hybrid, and/or any other cloud deployment model. Cloud resources 705 can be configured, in some cases, to support multiple deployment models. For example, cloud resources 705 can provide one set of computing resources through a public deployment model and another set of computing resources through a private deployment model.

In embodiments, software and/or hardware that performs one or more of the aspects, functions and/or processes described herein can be accessed and/or utilized by a client (e.g., an enterprise or an end user) as one or more of a SaaS, PaaS and IaaS model in one or more of a private, community, public, and hybrid cloud. Moreover, although aspects of the technical solutions described herein include a description of cloud computing, the systems and methods described herein are not limited to cloud computing and instead can be implemented on any suitable computing environment.

Cloud resources 705 can be configured to provide a variety of functionality that involves user interaction. Accordingly, a user interface (UI) can be provided for communicating with cloud resources 705 and/or performing tasks associated with cloud resources 705. The UI can be accessed via a client device 710 in communication with cloud resources 705. The UI can be configured to operate in a variety of client modes, including a fat client mode, a thin client mode, or a hybrid client mode, depending on the storage and processing capabilities of cloud resources 705 and/or client device 710. Therefore, a UI can be implemented as a standalone application operating at the client device in some embodiments. In other embodiments, a web browser-based portal can be used to provide the UI. Any other configuration to access cloud resources 705 can also be used in various implementations.

The foregoing examples have been provided merely for the purpose of explanation and are in no way to be construed as limiting of the present description. While aspects of the technical solutions described herein have been described with reference to an exemplary embodiment, it is understood that the words which have been used herein are words of description and illustration, rather than words of limitation. Changes can be made, within the purview of the appended claims, as presently stated and as amended, without departing from the scope and spirit of the technical solutions described herein in their aspects. Although aspects of the technical solutions have been described herein with reference to particular means, materials and embodiments, the present description is not intended to be limited to the particulars described herein; rather, the technical solutions described herein extend to all functionally equivalent structures, methods and uses, such as are within the scope of the appended claims.

Although an example computing system has been described in FIG. 9, the subject matter including the operations described in this specification can be implemented in other types of digital electronic circuitry, or in computer software, firmware, or hardware, including the structures described in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures described in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently described systems or methods, their components, acts, or elements to single or plural configurations. References to any act or element being based on any information, act or element may include implementations where the act or element is based at least in part on any information, act, or element.

Any implementation described herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations described herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the described elements and operations without departing from the scope of the technical solutions described herein.

References to “approximately,” “substantially”, or other terms of degree include variations of +/−10% from the given measurement, unit, or range unless explicitly indicated otherwise. Coupled elements can be electrically, mechanically, or physically coupled with one another directly or with intervening elements. Scope of the Systems and methods described herein is thus indicated by the appended claims, rather than the foregoing description, and changes that come within the meaning and range of equivalency of the claims are embraced therein.

What is claimed is:

1. A system, comprising:
one or more processors coupled with memory to:
receive, from a client device associated with a structure of entities, a data set indicative of resource utilization of the structure of entities, wherein the structure of entities comprises nodes that define related entities of the structure of entities using one or more parameters correlated with the data set;
receive criteria indicating a change in the data set from a second client device associated with a first entity of the structure of entities;
generate, using the criteria and the data set as inputs to a machine learning model, a scenario comprising impacts to a performance of the structure of entities;
determine that one or more of the impacts are above a threshold impact for a first node of the nodes; and
execute, responsive to the one or more impacts being above the threshold impact, an action associated with the scenario for the structure of entities to control an impact on the first node.

2. The system of claim 1, comprising the one or more processors to:
receive, from the first node, responsive to presenting the scenario to the first node, additional criteria from the client devices associated with the first node;
generate a second scenario by providing the criteria, the data set, and the additional criteria as inputs to the machine learning model; and
execute a second action associated with the second scenario for the structure of entities.

3. The system of claim 1, comprising the one or more processors to:
generate the scenario comprising a first plurality of scenarios by providing the criteria and the data set as inputs to the machine learning model;
determine that the one or more impacts are above the threshold impact for the first node for each scenario of the first plurality of scenarios; and
present each scenario of the first plurality of scenarios that are above the threshold impact to the first node via the client devices associated with the first node.

4. The system of claim 1, comprising the one or more processors to:
generate a plurality of second scenarios, responsive to presenting the scenario to the first node, by providing the criteria, the data set, and additional criteria from the first node as inputs to the machine learning model; and
receive, from the first entity, a selection of the scenario from the plurality of second scenarios.

5. The system of claim 1, comprising the one or more processors to:
generate a plurality of scenarios comprising the one or more impacts for each scenario of the plurality of scenarios by providing the criteria and the data set as inputs to the machine learning model;
determine a corresponding node of the nodes for each scenario of the plurality of scenarios with the one or more impacts above the threshold impact;
present each scenario of the plurality of scenarios to its corresponding node via the client devices associated with each corresponding node;
receive, from the client devices associated with each corresponding node, a selection of the scenario from the plurality of scenarios; and
execute the action associated with the scenario for the structure of entities based on the selected scenario.

6. The system of claim 1, comprising the one or more processors to:
identify a subset of the data set based on the criteria; and
provide the subset of the data set as input to the machine learning model to determine the one or more impacts.

7. The system of claim 1, comprising the one or more processors to:
present a confirmation of the action to the first entity; and
execute the action responsive to receiving an indication confirming execution of the action from the first entity.

8. The system of claim 1, wherein the structure of entities comprises entities related to one or more of: time entry, payroll, human resources, compensation, benefits, real estate, or finance.

9. The system of claim 1, comprising the one or more processors to select the action from a list of predetermined actions associated with the one or more impacts.

10. The system of claim 1, comprising the criteria to include a first change to the one or more parameters.

11. The system of claim 1, wherein the first node includes the first entity.

12. The system of claim 1, comprising the one or more processors to:
determine a suggestion of the criteria using historical data associated with the first entity as input to a second machine learning model using natural language learning;
present, via the client device associated with the first entity, the suggestion of the criteria; and
receive a selection of the criteria from the suggestion of the criteria.

13. A method comprising:
receiving, by one or more processors coupled with memory, from a client device associated with a structure of entities, a data set including resource utilization of the structure of entities, wherein the structure of entities comprises nodes, the nodes to define related entities of the structure of entities using one or more parameters correlated to the data set;
receiving, by the one or more processors, criteria defining a change in the data set from a client device associated with a first entity of the structure of entities;
generating, by the one or more processors, a scenario comprising impacts to a performance of the structure of entities by providing the criteria and the data set as inputs to a machine learning model;
determining, by the one or more processors, that one or more of the impacts are above a threshold impact for a first node of the nodes; and
executing, by the one or more processors, an action associated with the scenario for the structure of entities responsive to the one or more impacts being above the threshold impact.

14. The method of claim 13, comprising:
receiving, by the one or more processors, from the first node, responsive to presenting the scenario to the first node, additional criteria from client devices associated with the first node;
generating, by the one or more processors, a second scenario by providing the criteria, the data set, and the additional criteria as inputs to the machine learning model; and
executing, by the one or more processors, a second action associated with the second scenario for the structure of entities.

15. The method of claim 13, comprising:
generating, by the one or more processors, the scenario comprising a first plurality of scenarios by providing the criteria and the data set as inputs to the machine learning model;
determining, by the one or more processors, that the one or more impacts are above the threshold impact for the first node for each scenario of the first plurality of scenarios; and
presenting, by the one or more processors, each scenario of the first plurality of scenarios that are above the threshold impact to the first node via client devices associated with the first node.

16. The method of claim 13, comprising:
generating, by the one or more processors, a plurality of second scenarios, responsive to presenting the scenario to the first node, by providing the criteria, the data set, and additional criteria from the first node as inputs to the machine learning model; and
receiving, by the one or more processors, from the first entity, a selection of the scenario from the plurality of second scenarios.

17. The method of claim 13, comprising:
generating, by the one or more processors, a plurality of scenarios comprising the one or more impacts for each scenario of the plurality of scenarios by providing the criteria and the data set as inputs to the machine learning model;
determining, by the one or more processors, a corresponding node of the nodes for each scenario of the plurality of scenarios with the one or more impacts above the threshold impact;
presenting, by the one or more processors, each scenario of the plurality of scenarios to its corresponding node via client devices associated with each corresponding node;
receiving, by the one or more processors, from the client devices associated with each corresponding node, a selection of the scenario from the plurality of scenarios; and
executing the action associated with the scenario for the structure of entities based on the selected scenario.

18. The method of claim 13, comprising:
presenting a confirmation of the action to the first entity; and
executing the action responsive to receiving an indication confirming execution of the action from the first entity.

19. A non-transitory computer-readable medium, comprising instructions embodied thereon, the instructions to cause one or more processors to:
receive, from a client device associated with a structure of entities, a data set associated with a structure of entities comprising nodes, the nodes to define related entities of the structure of entities using one or more parameters correlated to the data set;
receive criteria defining a change in the data set from a client device associated with a first entity of the structure of entities;
generate a scenario comprising impacts to a performance of the structure of entities by providing the criteria and the data set as inputs to a machine learning model; and
execute an action associated with the scenario for the structure of entities.

20. The non-transitory computer-readable medium of claim 19, comprising the instructions to cause the one or more processors to:
receive, from the first entity, responsive to presenting the scenario to the first entity, additional criteria from the client devices associated with the first entity;
generate a second scenario by providing the criteria, the data set, and the additional criteria as inputs to the machine learning model; and
execute a second action associated with the second scenario for the structure of entities.
